(19) United States
(12) Patent Application Publication
(10) Pub. No.: US 2013/0260277 A1
(43) Pub. Date: Oct. 3, 2013

(54) DIFFUSION LAYER STRUCTURE OF FUEL CELL

(71) Applicant: HONDA MOTOR CO., LTD., Tokyo (JP)

(72) Inventors: Yoichi ASANO, Wako (JP); Takuma YAMAWAKI, Wako (JP); Takao FUKUMIZU, Wako (JP)

(73) Assignee: HONDA MOTOR CO., LTD., Tokyo (JP)

(21) Appl. No.: 13/850,301

(22) Filed: Mar. 26, 2013

(30) Foreign Application Priority Data
Mar. 28, 2012 (JP) 2012-074535

(51) Int. Cl. H01M 8/10

(52) U.S. Cl. CPC H01M 8/1002
USPC 429/480

(57) ABSTRACT

A diffusion layer structure of a fuel cell includes a diffusion layer and a microporous layer. P1/P2 is in a range of 2 to 15 where “P1” is defined as an actual measurement value of pressure drop caused when air penetrates through the diffusion layer having a penetration area of 1.86 cm² at a flow rate of 2 L/min and where “P2” is defined as a theoretical value of pressure drop defined by formula (1).

P2=thickness×10⁻⁷×(1−porosity)²/(mean flow pore size²×porosity³) formula (1)

where “thickness” indicates a thickness (μm) of the diffusion layer, “porosity” indicates a porosity (%) of the diffusion layer, and “mean flow pore size” indicates a mean flow pore size (μm) of the diffusion layer.

### CROSS-REFERENCE TO RELATED APPLICATIONS

The present application claims priority under 35 U.S.C. §119 to Japanese Patent Application No. 2012-074535, filed Mar. 28, 2012, entitled “Diffusion Layer Structure of Fuel Cell.” The contents of this application are incorporated herein by reference in their entirety.

### BACKGROUND OF THE INVENTION

1. Field of the Invention

The present disclosure relates to a diffusion layer structure of a fuel cell.

2. Discussion of the Background

In recent years, fuel cells that allow reactant gases to react electrochemically to generate electricity have been receiving attention as new power sources for automobiles, for example. It is believed that fuel cells are desirable from the viewpoint of achieving high electric generation efficiency because they directly generate electricity from electrochemical reactions. It is also believed that fuel cells are desirable from the viewpoint of achieving low environmental impact because they produce only harmless water at the time of power generation.

For example, a solid polymer electrolyte fuel cell has a stacked structure in which several tens to hundreds of cells are stacked. Each of the cells has a structure in which a membrane electrode assembly (MEA) is held between a pair of conductive separators. The MEA includes an anode (negative electrode), a cathode (positive electrode), and an electrolyte membrane held between these electrodes, the electrolyte membrane being composed of a sulfonic acid-based resin. Each of the electrodes includes an electrode catalyst layer in contact with the electrolyte membrane, the catalyst layer containing a platinum-based metal catalyst; and a conductive diffusion layer in contact with the electrode catalyst layer, the conductive diffusion layer serving to supply a reactant gas and discharge formed water. A fuel gas channel is formed in one separator, and an oxidizing gas channel is formed in the other.

For the solid polymer electrolyte fuel cell having the foregoing structure, hydrogen as a fuel gas is supplied to the anode through the fuel gas channel. Air as an oxidizing gas is supplied to the cathode through the oxidizing gas channel. Hydrogen supplied to the anode is protonated on the electrode catalyst layer. The formed protons are transferred to the cathode through the electrolyte membrane. At this time, electrons formed together with the protons are taken out to an external circuit and used as electric energy.

When the electrolyte membrane losses water, the conductivity is significantly reduced. Thus, the fuel gas and the oxidizing gas are usually humidified in advance and supplied to the cell. At this time, it is important that the diffusion layer efficiently supply the fuel gas and the oxidizing gas and smoothly discharge produced water. Thus, various studies have been conducted on the pore size, the density (porosity), water repellency, and so forth of the diffusion layer.

For example, a diffusion layer for a fuel cell is disclosed, the diffusion layer including a conductive water-repellent layer provided on a gas diffusion base, and the pore size of the conductive water-repellent layer being specified within a predetermined range (see Japanese Unexamined Patent Application Publication No. 2010-129310). A porous carbon sheet serving as a diffusion layer is disclosed, the porous carbon sheet being formed by bonding carbon fibers with a carbonized resin, and the pore size and the carbon fiber diameter being specified in predetermined ranges (see International Publication No. 2007/037084).

### SUMMARY OF THE INVENTION

According to one aspect of the present invention, a diffusion layer structure of a fuel cell includes a diffusion layer and a microporous layer. The microporous layer is provided on a side of the diffusion layer adjacent to an electrolyte membrane provided between electrodes in a membrane electrode assembly of the fuel cell. The microporous layer contains carbon and a fluorocarbon resin. The microporous layer has a water penetration pressure of 5 to 180 kPa. P1/P2 is in a range of 2 to 15 where “P1” is defined as an actual measurement value of pressure drop caused when air penetrates through the diffusion layer having a penetration area of 1.86 cm² at a flow rate of 2 L/min and where “P2” is defined as a theoretical value of pressure drop defined by formula (1).

P2=thickness×10⁻⁷×(1−porosity)²/(mean flow pore size²×porosity³) formula (1)

where “thickness” indicates a thickness (μm) of the diffusion layer, “porosity” indicates a porosity (%) of the diffusion layer, and “mean flow pore size” indicates a mean flow pore size (μm) of the diffusion layer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 schematically illustrates a diffusion layer structure of a solid polymer electrolyte fuel cell according to an embodiment of the present disclosure.

FIG. 2A illustrates the entire structure of a pressure-loss measurement apparatus, and FIG. 2B is a plan view of an air guide ring of the pressure-loss measurement apparatus.

FIG. 3 is a graph illustrating the relationship between pressure and flow rate measured by a bubble point method with a Perm Porometer.

FIG. 4 is a graph illustrating the relationship between P1/P2 and the terminal voltage.

FIG. 5 is a graph illustrating the relationship between the water penetration pressure of a microporous layer and the terminal voltage.

### DESCRIPTION OF THE EMBODIMENTS

The embodiments will now be described with reference to the accompanying drawings, wherein like reference numerals designate corresponding or identical elements throughout the various drawings.

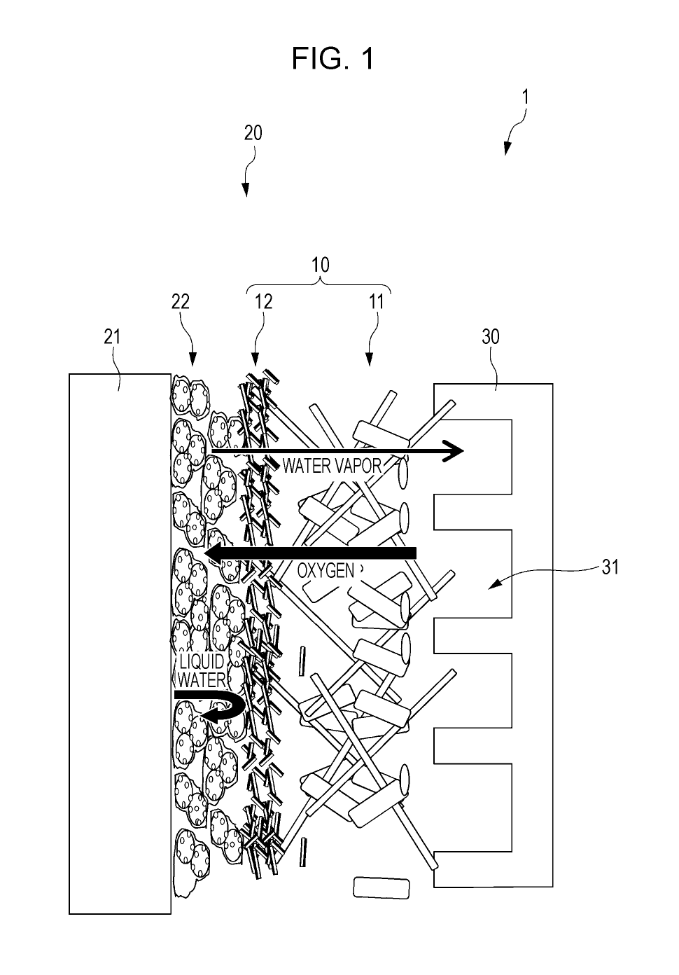

FIG. 1 schematically illustrates a diffusion layer structure 10 of a solid polymer electrolyte fuel cell 1 according to an embodiment of the present disclosure. FIG. 1 illustrates a cathode-side structure of the solid polymer electrolyte fuel cell 1. The diffusion layer structure 10 according to this embodiment is used only for a diffusion layer on the cathode side of the solid polymer electrolyte fuel cell 1.

The solid polymer electrolyte fuel cell 1 has a stacked structure (not illustrated) in which several tens to hundreds of cells are stacked. Each of the cells has a structure in which a membrane electrode assembly (MEA) 20 is held between a pair of conductive separators. As illustrated in FIG. 1, a cathode-side separator 30 includes an oxidant gas path 31.

The MEA 20 includes a solid polymer electrolyte membrane 21 provided between a cathode catalyst layer 22 and an anode catalyst layer. The solid polymer electrolyte membrane 21 is, for example, a perfluorosulfonic acid thin membrane impregnated with water. The cathode catalyst layer 22 and the anode catalyst layer contain porous carbon particles supporting platinum or the like on surfaces thereof. The diffusion layer structure 10 according to this embodiment is arranged on the cathode side of the MEA 20.

The diffusion layer structure 10 according to this embodiment includes a diffusion layer 11 and a microporous layer 12. The diffusion layer 11 is arranged so as to be in contact with the separator 30. The microporous layer 12 is formed on the diffusion layer 11 and in contact with the cathode catalyst layer 22.

The diffusion layer 11 has the function of diffusing oxygen serving as an oxidant gas and efficiently supplying oxygen to the entire cathode catalyst layer. As the diffusion layer 11, carbon paper which includes carbon fibers and a carbonized resin (binder resin) and which is subjected to water-repellent treatment with a fluorocarbon resin, e.g., tetrafluoroethylene-hexafluoropropylene (FEP) or polytetrafluoroethylene (PTFE), is used.

In the case where a diffusion layer is arranged so as to be in direct contact with a cathode catalyst layer, water produced in the cathode catalyst layer penetrates to the diffusion layer to cause a flooding phenomenon. The occurrence of the flooding phenomenon inhibits the supply of oxygen to the solid polymer electrolyte membrane to reduce electric power generation performance. Once the produced water accumulates in the diffusion layer, the accumulated water is not easily removed.

In this embodiment, the microporous layer 12 is thus arranged between the cathode catalyst layer 22 and the diffusion layer 11. As illustrated in FIG. 1, the microporous layer 12 has the properties that it is permeable to water vapor and oxygen and impermeable to liquid water. The arrangement of the microporous layer 12 having the properties between the cathode catalyst layer 22 and the diffusion layer 11 inhibits the occurrence of the flooding phenomenon in the diffusion layer 11.

The microporous layer 12 is mainly composed of carbon and a fluorocarbon resin. Examples of carbon that may be used include vapor-grown carbon fibers. Examples of the fluorocarbon resin that may be used include tetrafluoroethylene-hexafluoropropylene (FEP).

The microporous layer 12 is formed by preparing a paste containing carbon and the fluorocarbon resin, applying the paste onto the diffusion layer 11, and heat-treating the diffusion layer 11. Alternatively, a sheet formed from the paste may be used separately from the diffusion layer 11.

In this embodiment, letting the actual measurement value of pressure drop caused when air penetrates through the diffusion layer 11 be P1, and letting the theoretical value of the pressure drop, which is defined by formula (1) described above, of the diffusion layer 11 be P2, the ratio of P1 to P2, i.e., P1/P2, is in the range of 2 to 15. When the value of P1/P2 falls within the range, it is possible to achieve stable high electric power generation performance in a wide temperature range, regardless of humidification conditions.

An example of a method for adjusting the value of P1/P2 to the range of 2 to 15 is a method in which proportions of the carbon fibers and the carbonized resin (binder resin) in the carbon paper constituting the diffusion layer 11 are changed.

Here, a method for measuring the actual measurement value P1 of the pressure drop caused when air penetrates through the diffusion layer 11 will be described in detail.

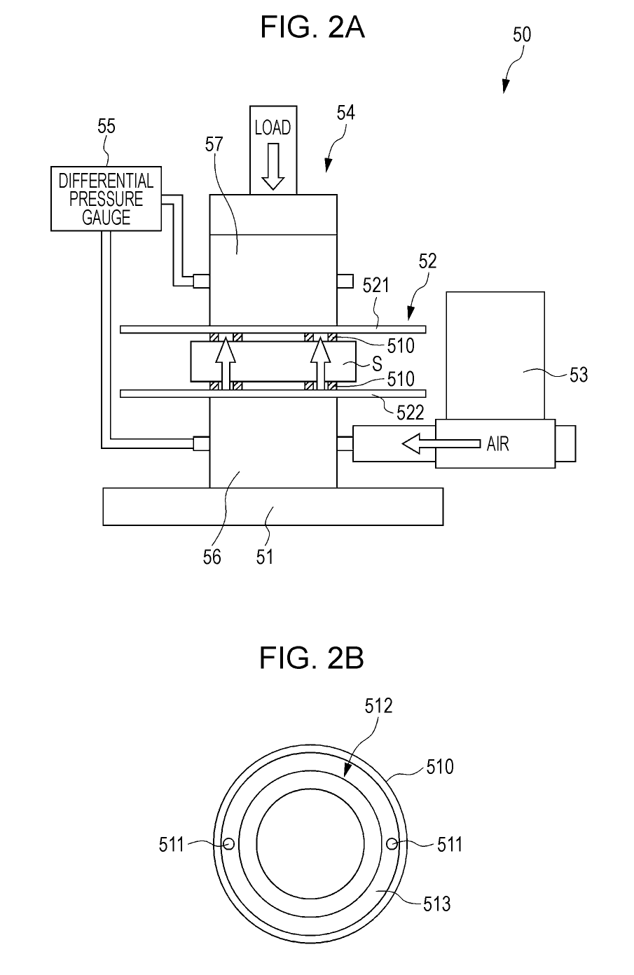

FIG. 2A illustrates the entire structure of a pressure-loss measurement apparatus 50. FIG. 2B is a plan view of an air guide ring 510 of the pressure-loss measurement apparatus 50.

As illustrated in FIG. 2A, the pressure-loss measurement apparatus 50 includes a base 51, a holder 52 configured to fix and hold a measurement sample S (diffusion layer 11), a mass flow controller 53 configured to supply air and control the flow rate of air supplied, a load cell 54 configured to apply a load to the measurement sample S in the thickness direction, an air inlet 56 configured to introduce air, an air outlet 57 which is open to the atmosphere and which is configured to exhaust air that has passed through the measurement sample S, and a differential pressure gauge 55 configured to measure a pressure difference between the air inlet 56 and the air outlet 57.

As illustrated in FIG. 2A, the holder 52 includes an upper plate 521 and a lower plate 522, which are substantially horizontally arranged and are opposite each other, and the air guide rings 510 which are arranged on the upper plate 521 and the lower plate 522 and which are located so as to be opposite each other with the measurement sample S provided therebetween.

As illustrated in FIG. 2B, each of the air guide rings 510 has a cylindrical shape and an annular groove 512 formed therein. The annular groove 512 is formed so as to be open to the measurement sample S side. Two holes 511 communicating with the air inlet 56 or the air outlet 57 are provided in connecting faces 513 of the air guide rings 510 to which the upper plate 521 and the lower plate 522 are connected. Thus, air is introduced from the air inlet 56 into the annular groove 512 of the air guide ring 510, arranged on the lower plate 522, through the holes 511. Air passing through the measurement sample S is introduced into the annular groove 512 of the air guide ring 510 arranged on the upper plate 521 and is then discharged into the air outlet 57 through the holes 511.

A procedure for measuring the pressure drop across the diffusion layer 11 with the pressure-loss measurement apparatus 50 will be described below.

The measurement sample S (diffusion layer 11) is held in the holder 52 with the air guide rings 510. A predetermined load is applied downward to the measurement sample S with the load cell 54. The supply of air is initiated from the mass flow controller 53. Air is introduced from the air inlet 56 into the annular groove 512 of the air guide ring 510 arranged on the lower plate 522 through the holes 511. The air supplied to the annular groove 512 of the air guide ring 510 penetrates the measurement sample S and is introduced into the annular groove 512 of the air guide ring 510 arranged so as to face the upper plate 521. The air is then discharged into the air outlet 57 through the holes 511. At this time, a pressure difference between the air inlet 56 and the air outlet 57 is measured with the differential pressure gauge 55. In this way, the actual measurement value P1 of the pressure drop across the measurement sample S (diffusion layer 11) is measured.

Measurement conditions with the pressure-loss measurement apparatus 50 are as follows: The penetration area of the measurement sample S (diffusion layer 11) may be 1.86 cm², the flow rate of air supplied may be 2 L/min, the gas pressure (injection pressure into the air inlet 56) may be 100 kPaG, and the surface pressure during the measurement may be 15 kgf/cm².

The theoretical value P2 of the pressure drop across the diffusion layer 11 will be described in detail below.

The theoretical value P2 of the pressure drop across the diffusion layer 11 is defined by formula (1) described below:

P2=thickness×10⁻⁷×(1−porosity)²/(mean flow pore size²×porosity³) formula (1)

where “thickness” indicates a thickness (μm) of the diffusion layer, “porosity” indicates a porosity (%) of the diffusion layer, and “mean flow pore size” indicates a mean flow pore size (μm) of the diffusion layer.

Here, the Kozeny-Carman equation is known as an equation that expresses the pressure drop (penetration pressure drop) of a single fluid flowing through a fixed bed. This equation is given by regarding paths in the bed as a group of uniform capillaries and applying the Poiseuille equation. Thus, letting the pressure drop of air flowing through the diffusion layer 11 be ΔP, ΔP is represented by formula (2) described below:

ΔP=150×viscosity×air velocity×(1−porosity)²×pore length/(pore size²×porosity³)=α×(1−porosity)²×pore length/(pore size²×porosity³) formula (2)

In formula (2), as “pore length”, the thickness (μm) of the diffusion layer 11 may be used. As “pore size”, a mean flow pore size (μm) may be used. α is a constant. It is thus understood that on the basis of formula (2), the theoretical value P2 of the pressure drop across the diffusion layer 11 can be defined as formula (1).

The mean flow pore size is measured by a bubble point method with a Perm Porometer (for example, Perm Porometer, manufactured by Porous Materials, Inc).

Here, the bubble point method is a technique for determining the maximum pore size and the minimum pore size of a sample by measuring a pressure required to push out a liquid with which pores are filled by surface tension and capillarity.

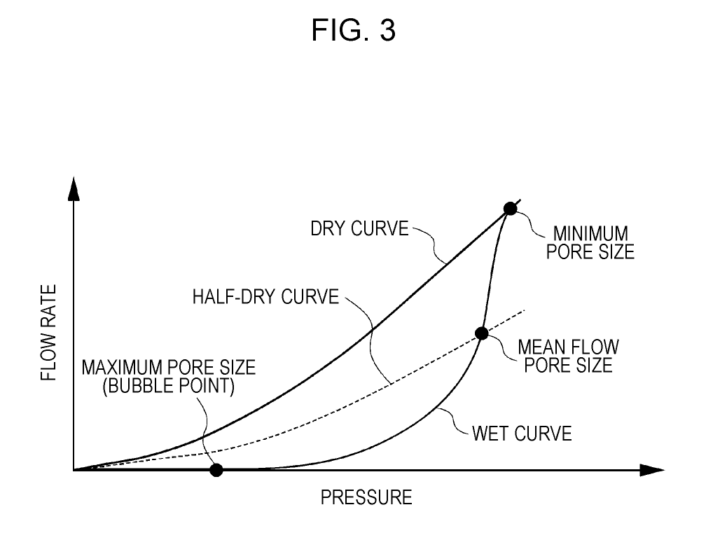

FIG. 3 is a graph illustrating the relationship between pressure and flow rate measured by the bubble point method with the Perm Porometer. As illustrated in FIG. 3, a sample is analyzed in dry and wet states by the bubble point method to provide a wet curve and a dry curve. In the wet curve, a point to initiate gas flow represents the maximum pore size (bubble point). The intersection point of the wet curve and the dry curve represents the minimum pore size. A half-dry curve that gives half of the flow rate in the dry curve is determined. The intersection point of the resulting half-dry curve and the wet curve represents the mean flow pore size.

In this embodiment, the theoretical value P2 of the pressure drop across the diffusion layer 11 is calculated from formula (1) using the mean flow pore size measured with the Perm Porometer.

In this embodiment, the water penetration pressure of the microporous layer 12 is in the range of 5 to 180 kPa. Here, the water penetration pressure indicates a pressure at which water starts to penetrate. In this embodiment, the water penetration pressure of the microporous layer 12 is measured as described below.

A microporous layer is formed on carbon paper to provide a measurement sample. Two milliliters of deionized water is dropped onto the microporous layer of the measurement sample to form a water film. A Perm Porometer (for example, a Perm Porometer manufactured by Porous Materials, Inc.) is used as a measurement apparatus. An air pressure is gradually applied to the water film. The minimum pressure required to allow deionized water to penetrate through the pores of the measurement sample is measured. The resulting minimum pressure is defined as the water penetration pressure of the microporous layer.

An example of a method for adjusting the water penetration pressure of the microporous layer 12 in the range of 5 to 180 kPa is a method in which the carbon content of the microporous layer 12 is changed.

This embodiment provides advantages described below.

In this embodiment, the microporous layer 12 mainly composed of carbon and a fluorocarbon resin is provided on the side of the diffusion layer 11 adjacent to the solid polymer electrolyte membrane 21. The ratio of the actual measurement value P1 to the theoretical value P2, which is represented by formula (1), of the pressure drop across the diffusion layer 11, i.e., P1/P2, is in the range of 2 to 15. Here, the ratio of the actual measurement value P1 to the theoretical value P2 of the pressure drop across the diffusion layer 11, i.e., P1/P2, is a parameter correlating with the sinuosity of the pores in the diffusion layer 11. That is, a higher value of P1/P2 indicates a higher degree of sinuosity in the diffusion layer 11 and indicates that the pores are more meandering. The value of P1/P2 is limited to the range of 2 to 15, thereby resulting in a low degree of sinuosity of the pores and a low pressure drop across the diffusion layer 11. Thus, water vapor produced in the cathode catalyst layer 22 is efficiently discharged. This leads to an increase in oxygen partial pressure in the vicinity of the cathode catalyst layer 22, thereby improving electric power generation performance. Furthermore, the efficient discharge of water vapor inhibits the condensation of water vapor at low temperatures, thereby inhibiting the occurrence of the flooding phenomenon. Therefore, in this embodiment, high electric power generation performance is provided over a wide range of temperatures, i.e., from low to high temperatures. In particular, high electric power generation performance is provided at low temperatures under high humidification conditions.

In this embodiment, the value of P1/P2 falls within the range described above, and the water penetration pressure of the microporous layer 12 is in the range of 5 to 180 kPa. This inhibits water produced in the cathode catalyst layer 22 from discharging through the microporous layer 12. In other words, the produced water can be held on the cathode catalyst layer 22 side to retain the moisture level in the MEA 20. Thus, high electric power generation performance is provided, regardless of humidification conditions. In particular, high electric power generation performance is provided at high temperatures under low-humidification conditions.

The present disclosure is not limited to the foregoing embodiment. Changes, improvements, and so forth may be made without departing from the scope of the present disclosure.

In the foregoing embodiment, while the microporous layer 12 is arranged so as to be in direct contact with the cathode catalyst layer 22, the present disclosure is not limited thereto. For example, a water-holding layer containing an electrolyte, carbon, and so forth may be arranged between the microporous layer 12 and the cathode catalyst layer 22. The arrangement of the water-holding layer further inhibits variations in electric power generation performance due to a change in humidification conditions.

### EXAMPLES

While the present disclosure will be described in more detail below on the basis of examples, the present disclosure is not limited to these examples.

### Example 1

### (1) Production of Cathode-Side Diffusion Layer and Anode-Side Diffusion Layer

As a cathode-side diffusion layer and an anode-side diffusion layer, the same diffusion layers were produced. Specifically, carbon paper having a mean flow pore size of 27 μm, a bulk density of 0.34 g/cm³, a thickness of 193 μm, a weight per unit area of 66.5 g/m², and a porosity of 0.80% was impregnated with a tetrafluoroethylene-hexafluoropropylene (FEP) copolymer dispersion (FEP 120-JRB, solid content: 54%, manufactured by Du Pont-Mitsui Fluorochemicals Company, Ltd.) and was then subjected to heat treatment at 120° C. for 30 minutes. The impregnation was performed in such a manner that the FEP content (% by weight) after the heat treatment was 2.4% by weight. Thereby, the cathode-side diffusion layer and the anode-side diffusion layer each formed of the carbon paper subjected to water-repellent treatment were produced.

The actual measurement value P1 of the pressure drop of the resulting cathode-side diffusion layer was measured with the pressure-loss measurement apparatus 50 and found to be 1.2 kPa. Measurement conditions of the actual measurement value P1 are as follows: The penetration area of the diffusion layer was 1.86 cm², the flow rate of air supplied was 2 L/min, the gas pressure (injection pressure into the air inlet 56) was 100 kPaG, and the surface pressure during the measurement was 15 kgf/cm² (the same is true for Examples 2 to 6 and Comparative Examples 1 to 6).

The theoretical value P2 of the pressure drop was determined from formula (1). The value of P1/P2 was calculated and found to be 6.5. The mean flow pore size of the carbon paper was measured with a Perm Porometer manufactured by Porous Materials, Inc. (the same applies hereinafter).

### (2) Preparation of Mixture Paste for Cathode-Side Microporous Layer

First, 12 g of vapor-grown carbon fibers (VGCF, manufactured by Showa Denko K.K.) having electron conductivity and pore-forming properties, 20 g of a tetrafluoroethylene-hexafluoropropylene (FEP) copolymer dispersion (FEP 120-JRB, solid content: 54%, manufactured by Du Pont-Mitsui Fluorochemicals Company, Ltd.), and 200 g of ethylene glycol were mixed together. The mixture was stirred with a ball mill, thereby preparing a mixture paste for a cathode-side microporous layer.

### (3) Preparation of Mixture Paste for Anode-Side Microporous Layer

First, 12 g of carbon (Vulcan XC72R, manufactured by Cabot Corp.), 20 g of a tetrafluoroethylene-hexafluoropropylene (FEP) copolymer dispersion (FEP 120-JRB, solid content: 54%, manufactured by Du Pont-Mitsui Fluorochemicals Company, Ltd.), and 155 g of ethylene glycol were mixed together. The mixture was stirred with a ball mill, thereby preparing a mixture paste for a anode-side microporous layer.

### (4) Production of Cathode-Side Microporous Layer

The mixture paste, prepared in item (2) described above, for the cathode-side microporous layer was applied onto the cathode-side diffusion layer, produced in item (1) described above, by screen printing and was then heat-treated at 380° C. for 30 minutes, thereby producing the cathode-side microporous layer. The screen printing was performed in such a manner that the weight of the cathode-side microporous layer per unit area of the carbon paper was 1.2 mg/cm² and that the pore volume of the cathode-side microporous layer per unit area of the carbon paper was 0.25 μL/cm². The pore size of the resulting cathode-side microporous layer was measured with a Perm Porometer manufactured by Porous Materials, Inc. and found to be 1.1 μm. The cathode-side microporous layer had a thickness of 35 μm. The water penetration pressure measured by the foregoing measurement method was 6.0 kPa.

### (5) Production of Anode-Side Microporous Layer

The mixture paste, prepared in item (3) described above, for the anode-side microporous layer was applied onto the anode-side diffusion layer, produced in item (1) described above, by screen printing and was then heat-treated at 380° C. for 30 minutes, thereby producing the anode-side microporous layer. The screen printing was performed in such a manner that the weight of the anode-side microporous layer was 1.2 mg/cm² and that the pore volume of the anode-side microporous layer was 0.09 μL/cm².

### (6) Preparation of Catalyst Paste

An ionic conductive polymer solution (DE2020CS, manufactured by E.I. du Pont de Nemours and Company) and a platinum catalyst (LSA, manufactured by BASF SE) were weighed in such a manner that the ratio by weight of DE2020CS to LSA, i.e., DE2020CS/LSA, was 0.1. They were mixed and stirred with a ball mill to prepare a catalyst paste.

### (7) Production of Electrode Catalyst Sheet

The catalyst paste prepared in item (6) was applied onto a PTFE sheet in such a manner that the weight of platinum was 0.7 mg/cm², and then was heat-treated at 120° C. for 60 minutes. Thereby, a cathode-side electrode catalyst sheet was produced.

The catalyst paste prepared in item (6) was applied onto a PTFE sheet in such a manner that the weight of platinum was 0.4 mg/cm², and then was heat-treated at 120° C. for 60 minutes. Thereby, an anode-side electrode catalyst sheet was produced.

### (8) Transfer to Polymer Electrolyte Membrane

The cathode-side electrode catalyst sheet prepared in item (7) was transferred to one surface of a polymer electrolyte membrane (Gore-Select, thickness: 20 μm, manufactured by Japan Gore-Tex Inc.) by a decal method. The anode-side electrode catalyst sheet prepared in item (7) was transferred to the other surface of the polymer electrolyte membrane by the decal method. Thereby, a cathode catalyst layer was formed on the one surface of the polymer electrolyte membrane, and an anode catalyst layer was formed on the other surface.

Here, the decal method for transfer indicates a method in which after the electrode catalyst layer side of the electrode catalyst sheet is bonded to the polymer electrolyte membrane by thermocompression bonding, the PTFE sheet is peeled off to transfer the electrode catalyst layer to a surface of the polymer electrolyte membrane.

### (9) Production of Membrane Electrode Assembly

The polymer electrolyte membrane including the electrode catalyst layer transferred in item (8) was sandwiched between the cathode-side diffusion layer including the cathode-side microporous layer formed in item (4) and the anode-side diffusion layer including the anode-side microporous layer formed in item (5). Thermocompression bonding was performed to produce a membrane electrode assembly. The thermocompression bonding was performed at 120° C. and a surface pressure of 30 kgf/cm² in such a manner that the cathode-side microporous layer was in contact with the cathode-side electrode catalyst layer and that the anode-side microporous layer was in contact with the anode-side electrode catalyst layer.

### (10) Evaluation of Electric Power Generation Performance

The membrane electrode assembly produced in item (9) was held by a pair of metal separators. Hydrogen as a fuel gas was supplied to the anode side. Air as an oxidant gas was supplied to the cathode side. The electric power generation performance was evaluated. Electric power generation conditions, such as a cell temperature, relative humidity at an anode gas inlet, relative humidity at a cathode gas inlet, anode stoichiometry, and cathode stoichiometry, are described in Table 1. The surface pressure of an electrode portion of the membrane electrode assembly was 15 kgf/cm². The area of the electrode portion of the membrane electrode assembly was 54.3 cm². The evaluation results are described in Table 2.

TABLE 1

| | Relative | Relative | | |
|---|---|---|---|---|
| Cell | humidity at | humidity at | Anode | Cathode |
| temperature | anode gas | cathode gas | stoichi- | stoichi- |
| (° C.) | inlet (%) | inlet (%) | ometry | ometry |
| 50 | 50 | 73 | 1.4 | 1.8 |
| 70 | 50 | 73 | 1.4 | 1.8 |
| 70 | 50 | 25 | 1.4 | 1.8 |
| 70 | 50 | 50 | 1.4 | 1.8 |

### Example 2

The same operation as in Example 1 was performed, except that in (1) Production of Cathode-Side Diffusion Layer and Anode-Side Diffusion Layer in Example 1, carbon paper having a mean flow pore size of 21 μm, a bulk density of 0.34 g/cm², a thickness of 195 μm, a weight per unit area of 67 g/m², and a porosity of 0.80% was used.

The actual measurement value P1 of the pressure drop across the resulting cathode-side diffusion layer was measured with the pressure-loss measurement apparatus 50 and found to be 1.2 kPa. The theoretical value P2 of the pressure drop was determined from formula (1). The value of P1/P2 was calculated and found to be 11.2. The evaluation results are described in Table 2.

### Example 3

The same operation as in Example 1 was performed, except that in (1) Production of Cathode-Side Diffusion Layer and Anode-Side Diffusion Layer in Example 1, carbon paper having a mean flow pore size of 27 μm, a bulk density of 0.31 g/cm², a thickness of 195 μm, a weight per unit area of 60.2 g/m², and a porosity of 0.82% was used.

The actual measurement value P1 of the pressure drop across the resulting cathode-side diffusion layer was measured with the pressure-loss measurement apparatus 50 and found to be 1.3 kPa. The theoretical value P2 of the pressure drop was determined from formula (1). The value of P1/P2 was calculated and found to be 5.2. The evaluation results are described in Table 2.

### Example 4

The same operation as in Example 1 was performed, except that in (2) Preparation of Mixture Paste for Cathode-Side Microporous Layer in Example 1, 12 g of vapor-grown carbon fibers (VGCF, manufactured by Showa Denko K.K.), 10 g of the tetrafluoroethylene-hexafluoropropylene (FEP) copolymer dispersion (FEP 120-JRB, solid content: 54%, manufactured by Du Pont-Mitsui Fluorochemicals Company, Ltd.), and 200 g of ethylene glycol were mixed together. The pore size of the resulting cathode-side microporous layer was measured with the Perm Porometer manufactured by Porous Materials, Inc. and found to be 0.9 μm. The cathode-side microporous layer had a thickness of 35 μm. The water penetration pressure measured by the foregoing measurement method (the same applies hereinafter) was 14.8 kPa. The evaluation results are described in Table 2.

### Example 5

The same operation as in Example 1 was performed, except that a conductive porous sheet (pore size: 0.6 μm, thickness: 38 μm, water penetration pressure: 45.1 kPa) containing a resin and carbon was used in place of the cathode-side microporous layer produced in item (4) in Example 1 and that in (9) Production of Membrane Electrode Assembly in Example 1, the conductive porous sheet was placed on the carbon paper so as not to make a wrinkle, and then bonded to an electrode at 120° C. and a surface pressure of 30 kgf/cm². The evaluation results are described in Table 2.

### Example 6

The same operation as in Example 1 was performed, except that a conductive porous sheet (pore size: 0.4 μm, thickness: 41 μm, water penetration pressure: 134.4 kPa) containing a resin and carbon in place of the cathode-side microporous layer produced in item (4) in Example 1 and that in (9) Production of Membrane Electrode Assembly in Example 1, the conductive porous sheet was placed on the carbon paper so as not to make a wrinkle, and then bonded to an electrode at 120° C. and a surface pressure of 30 kgf/cm². The evaluation results are described in Table 2.

### Comparative Example 1

The same operation as in Example 1 was performed, except that in (1) Production of Cathode-Side Diffusion Layer and Anode-Side Diffusion Layer in Example 1, carbon paper having a mean flow pore size of 22 μm, a bulk density of 0.47 g/cm², a thickness of 188 μm, a weight per unit area of 88 g/m², and a porosity of 0.73% was used.

The actual measurement value P1 of the pressure drop of the resulting cathode-side diffusion layer was measured with the pressure-loss measurement apparatus 50 and found to be 0.9 kPa. The theoretical value P2 of the pressure drop was determined from formula (1). The value of P1/P2 was calculated and found to be 19.4. The evaluation results are described in Table 3.

### Comparative Example 2

The same operation as in Example 1 was performed, except that in (1) Production of Cathode-Side Diffusion Layer and Anode-Side Diffusion Layer in Example 1, carbon paper having a mean flow pore size of 14 μm, a bulk density of 0.35 g/cm³, a thickness of 204 μm, a weight per unit area of 71 g/m², and a porosity of 0.80% was used.

The actual measurement value P1 of the pressure drop of the resulting cathode-side diffusion layer was measured with the pressure-loss measurement apparatus 50 and found to be 1.3 kPa. The theoretical value P2 of the pressure drop was determined from formula (1). The value of P1/P2 was calculated and found to be 25.7. The evaluation results are described in Table 3.

### Comparative Example 3

The same operation as in Example 1 was performed, except that in (1) Production of Cathode-Side Diffusion Layer and Anode-Side Diffusion Layer in Example 1, carbon paper having a mean flow pore size of 25 μm, a bulk density of 0.27 g/cm³, a thickness of 185 μm, a weight per unit area of 50 g/m², and a porosity of 0.84% was used.

The actual measurement value P1 of the pressure drop of the resulting cathode-side diffusion layer was measured with the pressure-loss measurement apparatus 50 and found to be 0.4 kPa. The theoretical value P2 of the pressure drop was determined from formula (1). The value of P1/P2 was calculated and found to be 1.6. The evaluation results are described in Table 3.

### Comparative Example 4

The same operation as in Example 1 was performed, except that in (1) Production of Cathode-Side Diffusion Layer and Anode-Side Diffusion Layer in Example 1, carbon paper having a mean flow pore size of 12 μm, a bulk density of 0.33 g/cm², a thickness of 208 μm, a weight per unit area of 68 g/m², and a porosity of 0.81% was used.

The actual measurement value P1 of the pressure drop of the resulting cathode-side diffusion layer was measured with the pressure-loss measurement apparatus 50 and found to be 1.79 kPa. The theoretical value P2 of the pressure drop was determined from formula (1). The value of P1/P2 was calculated and found to be 44.5. The evaluation results are described in Table 3.

### Comparative Example 5

The same operation as in Example 5 was performed, except that a conductive porous sheet having a pore size of 0.1 μm, a thickness of 48 μm, and a water penetration pressure of 202.5 kPa was used in place of the conductive porous sheet serving as a cathode-side microporous layer in Example 5. The evaluation results are described in Table 3.

### Comparative Example 6

The same operation as in Example 1 was performed, except that in (2) Preparation of Mixture Paste for Cathode-Side Microporous Layer in Example 1, 12 g of carbon (Vulcan XC72R, manufactured by Cabot Corp.), 20 g of a tetrafluoroethylene-hexafluoropropylene (FEP) copolymer dispersion (FEP 120-JRB, solid content: 54%, manufactured by Du Pont-Mitsui Fluorochemicals Company, Ltd.), and 155 g of ethylene glycol were mixed together.

The pore size of the resulting cathode-side microporous layer was measured with a Perm Porometer manufactured by Porous Materials, Inc. and found to be 12.1 μm. The cathode-side microporous layer had a thickness of 39 μm. The water penetration pressure measured by the foregoing measurement method was 3.2 kPa. The evaluation results are described in Table 3.

TABLE 2

| | | Example | | | | | |
|---|---|---|---|---|---|---|---|
| | | 1 | 2 | 3 | 4 | 5 | 6 |
| Diffusion | Thickness | 193 | 195 | 195 | 193 | 193 | 193 |
| layer | (μm, 150 kPa) | | | | | | |
| | Weight per unit | 66.5 | 67.0 | 60.2 | 66.5 | 66.5 | 66.5 |
| | area (g/m²) | | | | | | |
| | Bulk density | 0.34 | 0.34 | 0.31 | 0.34 | 0.34 | 0.34 |
| | (g/cm³) | | | | | | |
| | Porosity (%) | 0.80 | 0.80 | 0.82 | 0.80 | 0.80 | 0.80 |
| | Mean flow pore | 27 | 21 | 27 | 27 | 27 | 27 |
| | size (μm) | | | | | | |
| | P1/P2 | 6.5 | 11.2 | 5.2 | 6.5 | 6.5 | 6.5 |
| | P1 (kPa) | 1.2 | 1.2 | 1.3 | 1.2 | 1.2 | 1.2 |
| Micro- | Paste/sheet | paste | paste | paste | paste | sheet | sheet |
| porous | Pore size (μm) | 1.1 | 1.1 | 1.1 | 0.9 | 0.6 | 0.4 |
| layer | Thickness (μm) | 35 | 35 | 35 | 35 | 38 | 41 |
| | Water | 6.0 | 6.0 | 6.0 | 14.8 | 45.1 | 134.4 |
| | penetration | | | | | | |
| | pressure (kPa) | | | | | | |
| Terminal | 50° C. | 0.634 | 0.615 | 0.643 | 0.632 | un- | 0.632 |
| voltage | | | | | | measured | |
| A/C = | 70° C. | 0.675 | 0.673 | 0.651 | 0.667 | 0.664 | 0.662 |
| 50/73% RH | | | | | | | |
| fixed | | | | | | | |
| Terminal | A/C = 50/25% RH | 0.631 | un- | un- | 0.644 | 0.655 | 0.659 |
| voltage | | | measured | measured | | | |
| 70° C. fixed | A/C = 50/73% RH | 0.675 | un- | un- | 0.667 | 0.664 | 0.662 |
| | | | measured | measured | | | |

TABLE 3

| | | Comparative Example | | | | | |
|---|---|---|---|---|---|---|---|
| | | 1 | 2 | 3 | 4 | 5 | 6 |
| Diffusion | Thickness | 188 | 204 | 185 | 208 | 193 | 193 |
| layer | (μm, 150 kPa) | | | | | | |
| | Weight per unit | 88.0 | 71.0 | 50.0 | 68.0 | 66.5 | 66.5 |
| | area (g/m²) | | | | | | |
| | Bulk density | 0.47 | 0.35 | 0.27 | 0.33 | 0.34 | 0.34 |
| | (g/cm³) | | | | | | |
| | Porosity (%) | 0.73 | 0.80 | 0.84 | 0.81 | 0.80 | 0.80 |
| | Mean flow pore | 22 | 14 | 25 | 12 | 27 | 27 |
| | size (μm) | | | | | | |
| | P1/P2 | 19.4 | 25.7 | 1.6 | 44.5 | 6.5 | 6.5 |
| | P1 (kPa) | 0.9 | 1.3 | 0.4 | 1.79 | 1.2 | 1.2 |
| Micro- | Paste/sheet | paste | paste | paste | paste | sheet | paste |
| porous | Pore size (μm) | 1.1 | 1.1 | 1.1 | 1.1 | 0.1 | 12.1 |
| layer | Thickness | 35 | 35 | 35 | 35 | 48 | 39 |
| | (μm) | | | | | | |
| | Water | 6.0 | 6.0 | 6.0 | 6.0 | 202.5 | 3.2 |
| | penetration | | | | | | |
| | pressure (kPa) | | | | | | |
| Terminal | 50° C. | 0.57 | 0.52 | 0.62 | 0.53 | 0.32 | un- |
| voltage | | | | | | | measured |
| A/C = | 70° C. | 0.66 | 0.65 | 0.63 | 0.63 | 0.60 | un- |
| 50/73% RH | | | | | | | measured |
| fixed | | | | | | | |
| Terminal | A/C = 50/25% RH | un- | un- | un- | un- | 0.64 | 0.58 |
| voltage | | measured | measured | measured | measured | | |
| 70° C. fixed | A/C = 50/73% RH | un- | un- | un- | un- | 0.60 | 0.68 |
| | | measured | measured | measured | measured | | |

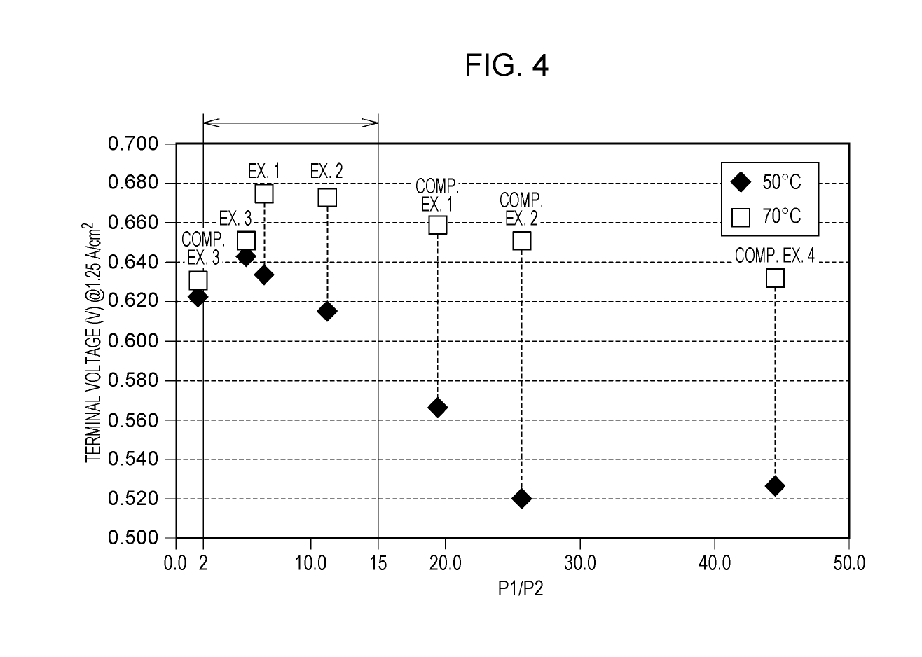

FIG. 4 is a graph illustrating the relationship between P1/P2 and the terminal voltage (1.25 A/cm²) on the basis of the results described in Tables 2 and 3. FIG. 4 demonstrates that in Examples 1 to 3, in which the values of P1/P2 were in the range of 2 to 15, high electric power generation performance was provided at both 50° C. and 70° C., compared with Comparative Examples 1 to 4, in which the values of P1/P2 were outside the range of 2 to 15. The results demonstrate that in the present disclosure in which the value of P1/P2 is in the range of 2 to 15, high electric power generation performance is stably provided in a wide temperature range.

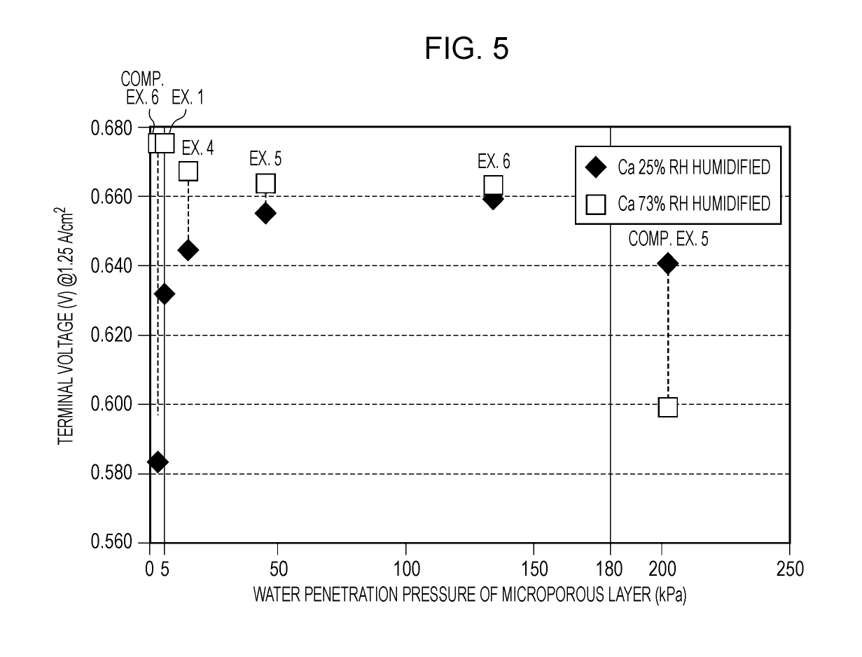

FIG. 5 is a graph illustrating the relationship between the water penetration pressure of the microporous layer and the terminal voltage (1.25 A/cm²) on the basis of the results described in Tables 2 and 3. FIG. 5 demonstrates that in Examples 1 and Comparative Examples 4 to 6, in which the water penetration pressure of the microporous layer was in the range of 5 to 180 kPa, high electric power generation performance was provided under any humidification conditions, i.e., at relative humidities of both 25% and 73%, at the cathode gas inlet, compared with Comparative Examples 5 and 6, in which the water penetration pressure of the microporous layer was outside the range of 5 to 180 kPa. The results demonstrate that in the present disclosure in which the water penetration pressure of the microporous layer is in the range of 5 to 180 kPa, high electric power generation performance is stably provided, regardless of humidification conditions.

Accordingly, in the present disclosure in which the value of P1/P2 is in the range of 2 to 15 and in which the water penetration pressure of the microporous layer is in the range of 5 to 180 kPa, high electric power generation performance is stably provided in a wide temperature range, regardless of humidification conditions.

According to an embodiment of the present disclosure, a diffusion layer structure (for example, a diffusion layer structure 10 described below) of a fuel cell (for example, a solid polymer electrolyte fuel cell 1), the diffusion layer structure being arranged in a membrane electrode assembly (for example, a membrane electrode assembly 20 described below) that includes an electrolyte membrane (for example, a solid polymer electrolyte membrane 21 described below) provided between electrodes, includes a diffusion layer (for example, a diffusion layer 11 described below) and a microporous layer (for example, a microporous layer 12) provided on a side of the diffusion layer adjacent to the electrolyte membrane, the microporous layer being mainly composed of carbon and a fluorocarbon resin, in which letting the actual measurement value of pressure drop caused when air penetrates through the diffusion layer having a penetration area of 1.86 cm² at a flow rate of 2 L/min be P1, and letting the theoretical value of the pressure drop defined by formula (1) described below be P2, the ratio of P1 to P2, i.e., P1/P2, is in the range of 2 to 15, and in which the microporous layer has a water penetration pressure of 5 to 180 kPa,

P2=thickness×10⁻⁷×(1−porosity)²/(mean flow pore size²×porosity³) formula (1)

where “thickness” indicates a thickness (μm) of the diffusion layer, “porosity” indicates a porosity (%) of the diffusion layer, and “mean flow pore size” indicates a mean flow pore size (μm) of the diffusion layer.

In the embodiment, the microporous layer mainly composed of carbon and the fluorocarbon resin is provided on a side of the diffusion layer adjacent to the electrolyte membrane. The ratio of the actual measurement value P1 to the theoretical value P2 of the pressure drop across the diffusion layer, i.e., P1/P2, is in the range of 2 to 15.

Here, the ratio of the actual measurement value P1 to the theoretical value P2 of the pressure drop across the diffusion layer, i.e., P1/P2, is a parameter correlating with the sinuosity of the pores in the diffusion layer. That is, a higher value of P1/P2 indicates a higher degree of sinuosity in the diffusion layer and indicates that the pores are more meandering. The value of P1/P2 is limited to the range of 2 to 15, thereby resulting in a low degree of sinuosity of the pores and a low pressure drop across the diffusion layer. Thus, water vapor produced in the cathode catalyst layer is efficiently discharged. This leads to an increase in oxygen partial pressure in the vicinity of the electrode, thereby improving electric power generation performance. Furthermore, the efficient discharge of water vapor inhibits the condensation of water vapor at low temperatures, thereby inhibiting the occurrence of the flooding phenomenon. Therefore, in the present disclosure, high electric power generation performance is provided over a wide range of temperatures, i.e., from low to high temperatures. In particular, high electric power generation performance is provided at low temperatures under high humidification conditions.

In the embodiment, the value of P1/P2 falls within the range described above, and the water penetration pressure of the microporous layer is in the range of 5 to 180 kPa. This inhibits water produced in the electrode from discharging through the microporous layer. In other words, the produced water can be held on the electrode side to retain the moisture level in the membrane electrode assembly. Thus, high electric power generation performance is provided, regardless of humidification conditions. In particular, high electric power generation performance is provided at high temperatures under low-humidification conditions.

According to the embodiment, it is possible to provide a diffusion layer structure of a fuel cell that stably provides high electric power generation performance in a wide temperature range regardless of humidification conditions.

Obviously, numerous modifications and variations of the present invention are possible in light of the above teachings. It is therefore to be understood that within the scope of the appended claims, the invention may be practiced otherwise than as specifically described herein.

What is claimed is:

1. A diffusion layer structure of a fuel cell, the diffusion layer structure comprising:
a diffusion layer; and
a microporous layer provided on a side of the diffusion layer adjacent to an electrolyte membrane provided between electrodes in a membrane electrode assembly of the fuel cell, the microporous layer containing carbon and a fluorocarbon resin, the microporous layer having a water penetration pressure of 5 to 180 kPa, P1/P2 being in a range of 2 to 15 where “P1” is defined as an actual measurement value of pressure drop caused when air penetrates through the diffusion layer having a penetration area of 1.86 cm² at a flow rate of 2 L/min and where “P2” is defined as a theoretical value of pressure drop defined by formula (1),
P2=thickness×10⁻⁷×(1−porosity)²/(mean flow pore size²×porosity³) formula (1)
where “thickness” indicates a thickness (μm) of the diffusion layer, “porosity” indicates a porosity (%) of the diffusion layer, and “mean flow pore size” indicates a mean flow pore size (μm) of the diffusion layer.

2. The diffusion layer structure of a fuel cell according to claim 1, wherein the microporous layer allows water vapor and oxygen to pass through the microporous layer and prevents liquid water from passing through the microporous layer.
